(19) United States
(12) Patent Application Publication
(10) Pub. No.: US 2019/0078692 A1
(43) Pub. Date: Mar. 14, 2019

(54) BALL VALVE AND MANUFACTURING METHOD

(71) Applicant: RUBINETTERIE UTENSILERIE BONOMI S.r.l., Mazzano, Brescia (IT)

(72) Inventors: Giuliano BONOMI, Mazzano, Brescia (IT); Sandro RABAIOLI, Mazzano, Brescia (IT)

(21) Appl. No.: 16/079,845

(22) PCT Filed: Feb. 23, 2017
(86) PCT No.: PCT/IB2017/051031

§ 371 Date: Aug. 24, 2018

(30) Foreign Application Priority Data
Feb. 26, 2016 (IT) 102016000020351

(51) Int. Cl. F16K 11/087; F16K 11/056

(52) U.S. Cl. CPC F16K 11/0873; F16K 5/0642; F16K 11/056

(57) ABSTRACT

A ball valve includes a valve body that delimits a sealing seat, a ball seat and at least three fluidic ducts that converge in the ball seat. A hollow ball is received in the ball seat and is movable to allow/prevent fluidic communication between the fluidic ducts. At least one of at least two sealing elements is placed into the sealing seat in abutment with the ball. Only one of the ducts acts as an introduction duct of the sealing element and of the hollow ball inside the valve body, to position the sealing element and hollow ball into their respective seats. A ball-compressing element delimits a further sealing seat to receive the other sealing element and is connected to the introduction duct of the valve body to press the element against the ball. A manufacturing method makes the ball valve.

The present invention relates to a ball valve with at least three ways, and to a manufacturing method of a ball valve.

A traditional manufacturing method of a three-way ball valve provides for the formation of an outer structure, the positioning of sealing means into the structure and the retention of such means by means of three separate locking elements (so called “ball pressing elements”).

The latter are essentially annular elements which, once connected to the outer structure, compress and retain the sealing means to ensure a sealing of the valve in the various positions of the ball.

Such solution has the advantage of allowing the positioning of the sealing means after the ball has been placed into the outer structure.

However, the known solution entails a series of drawbacks, not least the high number of components to be associated to the structure, and a considerable size of the latter to prevent undesirable interactions between the threads required for the connection of the ball pressing elements.

The present invention belongs to such context, offering to provide a valve and a method capable of overcoming the aforesaid drawbacks. In particular, the present invention allows to obtain the concomitant effects of reducing the total number of pieces required for the correct operation of the valve, and of considerably limiting the encumbrance and the weight of the valve, at least in a parity of fluid delivered to the interior thereof.

Such objective is achieved by means of a ball valve according to claim 1, and by means of a method according to claim 9. The claims dependent therefrom show variants of preferred embodiments.

The object of the present invention will now be described in detail, with the aid of the attached figures, in which:

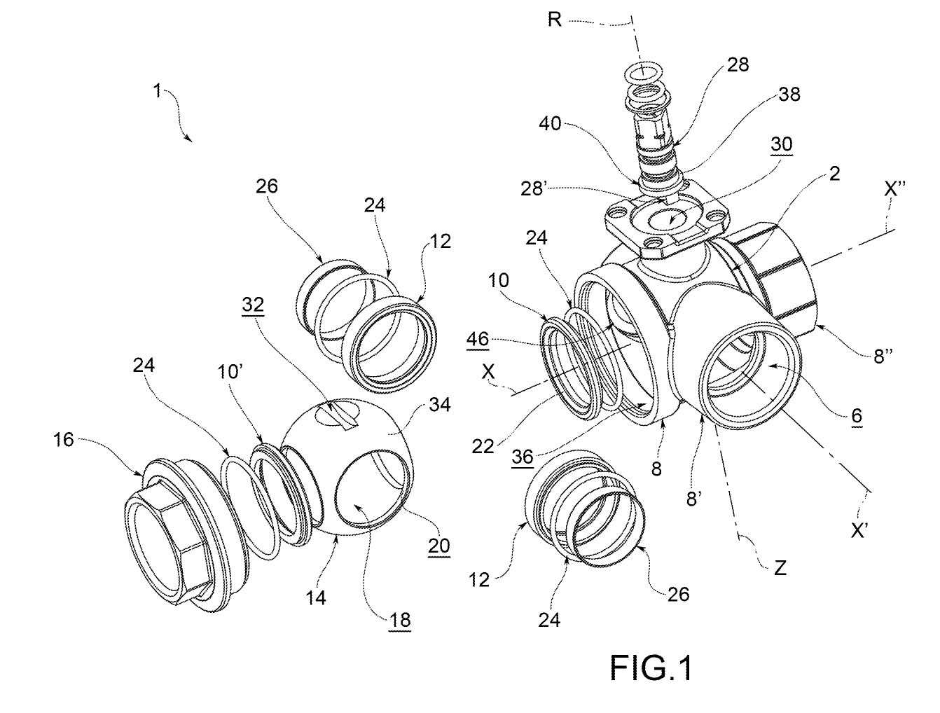

FIG. 1 shows an exploded view of a ball valve, object of the present invention, according to a possible embodiment;

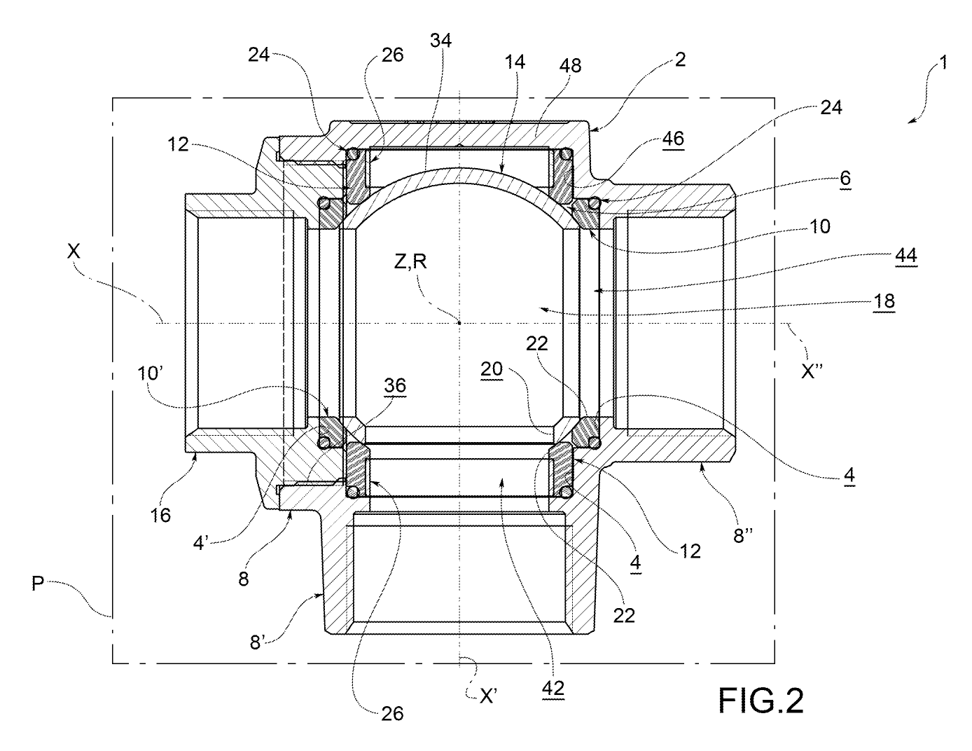

FIG. 2 shows a section of the assembled valve of FIG. 1, along the plane P in which the development axes of the three fluidic ducts are arranged.

With reference to the above Figures, reference number 1 describes, in its totality, a ball valve.

Such valve 1 comprises a valve body 2, at least one hollow ball 14, two or more sealing elements 10, 10′, 12 and a ball-compressing element 16.

The valve body 2 delimits at least one sealing seat 4, 46, a ball seat 6 and at least three fluidic ducts 8, 8′, 8″ that converge in the ball seat 6.

According to a variant, the valve body 2 delimits a single ball seat 6.

According to a further variant, the valve body 2 delimits two or three sealing seats 4, 46. According to such variant, the valve 1 preferably comprises sealing elements 10, 12 in equal number with respect to the number of such seats 4, 46.

According to an even further variant, the valve body 2 delimits three or four fluidic ducts 8, 8′, 8″.

For the embodiment of a valve with at least three ways, the at least three fluidic ducts 8, 8′, 8″ preferably develop around development axes X, X′, X″ which lie substantially in a same plane P, as outlined for example in FIG. 2.

In a not-shown embodiment, relating to valves with at least four ways, such valve may comprise an optional fourth duct which develops about a further development axis Z (outlined for example in FIGS. 1, 2) incident, preferably orthogonal, with respect the aforesaid plane P.

In a further non-shown embodiment, relating to valves with at least four ways, such valve may comprise an optional fourth duct which develops about a further development axis Z lying in the same plane P in which the development axes X, X′, X″ of the other fluidic ducts 8, 8′, 8″ are placed.

Preferably, the valve body 2 delimits a sealing seat 4 to a proximal inlet 42, 44 of only two fluidic ducts 8′, 8″, where the term “proximal” refers to the closeness or proximity to the ball seat 6.

Optionally, one of the fluidic ducts 8′ may be facing a body wall 48 of the valve body 2 which, along the development axis X′, overlaps in a prevalent or complete manner the passage section of such duct 8′.

According to such embodiment, a sealing seat 46 may be identified at the body wall 48 and, more precisely, between the body wall 48 and the hollow ball 14.

According to a possible variant of the valve with at least four ways, the optional fourth duct may be placed at (specifically: in partial or complete replacement) the body wall 48 just discussed.

The hollow ball 14 is received in the ball seat 6 and is movable with respect to the valve body 2 to allow/prevent the fluidic communication between the aforesaid fluidic ducts 8, 8′, 8″, for example between pairs of ducts.

According to a preferred variant, the valve 1 comprises hollow balls 14 in equal number with respect to the ball seats 6 delimited by the valve body 2.

Preferably, the hollow ball 14 is rotatable with respect the valve body 2 about a rotation axis R. For example, the rotation axis R may be orthogonal to the plane P.

More precisely, the ball valve 1 may comprise a control rod 28 of the hollow ball 14, inserted in a rod seat 30 delimited by the valve body 2, in a manner partially protruding from such body. Preferably, the rod seat 30 is adjacent to the ball seat 6.

In the embodiment outlined in FIG. 1, the control rod 28 is preferably inserted/engaged in an outer slit 32 of the hollow ball 14, in particular at a first end portion 28′ thereof. Advantageously, such first end portion 28′ is conformed to be coupled by shape and/or with force to the outer slit 32.

Optionally, the control rod 28 may comprise a rod projection 40 delimiting an annular surface 38 configured to abut against an inner surface (not visible in the Figures, but facing the ball seat 6) of the valve body 1. For example, the rod projection 40 is placed at the first end portion 28′.

At a second end portion 28″ of the control rod 28 an actuator element may be fastened (not shown), for example a knob or a lever, to move the hollow ball 14 preferably in rotation.

In relation to the number of ducts which may be put in communication to one another, this depends on the type of through cavity 18 the hollow ball 14 identifies inside itself.

According to various embodiments, the through cavity 18 may be substantially cylindrical, having an “L” or “T” shape, the latter variant being for example shown in the figures.

According to a particularly preferred embodiment, the through cavity 18 has at least one annular inlet 20 (preferably: all the inlets thereof) of a size at least equal to or greater than an inner edge 22 of the sealing element 10, 12 received in the valve body 2.

As a result, according to such variant, the annular inlet 20 does not protrude into the fluidic ducts.

With regard to the fluidic ducts 8, 8′, 8″, one or more ducts preferably comprise mechanical means for coupling with one or more outer ducts (not shown in the figures), to which the present valve 1 is joinable.

By way of example, the mechanical coupling means may comprise an inner thread of the fluidic duct 8, 8′, 8″, an outer thread, or a nut coupling (of the “nut-and-tail” type).

At least one of the two or more sealing elements 10, 10′, 12 is placed in the sealing seat 4, 46 in abutment with the hollow ball 14 and, more precisely, in abutment with an outer surface 34 of the latter.

Only one of the aforementioned fluidic ducts acts as an introduction duct 8 of the sealing element 10, 12 and of the hollow ball 14 inside the valve body 2, for positioning such element 10, 12 and such ball 14 respectively in the sealing seat 4, 46 and in the ball seat 6.

As a result, preferably, the introduction duct 8 circumscribes a transit section 36 greater than the encumbrance of the hollow ball 14 and than the encumbrance of the sealing element 10, 12, or the plurality of sealing elements, associated to the valve body 2.

Thereby, all of the components discussed above may be introduced from the same side of the valve body, by means of the introduction duct 8.

The ball valve 1 further comprises a ball-compressing element 16 delimiting a further sealing seat 4′ to receive the other sealing element 10′ and connected to the introduction duct 8 of the valve body 2 to press such element 10′ against the hollow ball 14.

Therefore, in addition to the sealing elements 10, 12 discussed above, the valve comprises another sealing element 10′ placed at the ball-compressing element, so that the latter may press the element 10′ against the hollow ball.

In the embodiment shown, the ball-compressing element 16 comprises an annular body fastened to the introduction duct 8.

According to the discussed variants, any one of the sealing elements 10, 10′, 12 may be of annular or tubular shape. Preferably, one or more of the sealing elements 10, 10′, 12 develops around the respective development axis X, X′, X″, and is preferably mounted coaxially to the fluidic duct.

Merely by way of example, the ball-compressing element 16 is joined, for example screwed and/or welded, in an irreversible manner to the valve body 2.

According to an advantageous variant, the valve 1 comprises an elastic element 24 at at least one sealing seat 4, 4′, 46, more precisely between the sealing element 10, 12 and the valve body 2 and/or between the other sealing element 10′ and the ball-compressing element 16.

The elastic element 24 is advantageously compressible by the hollow ball 14 to insert it into, and possibly remove it from, the ball seat 6.

Specifically, since the hollow ball 14 is inserted in the seat 6 thereof after one or more sealing elements 10, 12 were placed, the insertion of the ball may be uncomfortable due to the encumbrance of the elements already positioned in the valve body.

According to a preferred variant, one or more sealing elements 12 are coupled to a reinforcement element 26 (for example of an annular or tubular shape), at least partially inserted into the sealing seat 4, 46 to limit deformation of said sealing element 12 upon movement of the hollow ball 14 in the ball seat 6.

In the shown embodiments, the reinforcement element 26 is at least partially received in the sealing element 12. Preferably, with respect to the development axis X, X′, X″, the reinforcement element 26 is radially internally arranged with respect to the sealing element 12.

Advantageously, the elastic element 24 and/or the reinforcement element 26—if provided—are introduced into the valve body 2, at the sealing seat 4, 46, by means of the introduction duct 8.

The aforesaid objectives are also achieved by means of a manufacturing method of a ball valve as described below.

Preferably, such manufacturing method is aimed at obtaining the ball valve 1 according to any of the previous embodiments. As a result, even where this is not expressly stated, such method may comprise any preferred or incidental feature deductible—from the process or the structure point of view—from the above description.

The manufacturing method comprises the steps of:
i) providing a valve body 2 which delimits at least one sealing seat 4, 46, a ball seat 6 and at least three fluidic ducts 8, 8′, 8″ which converge in the ball seat 6;
ii) through only one of such fluidic ducts, which acts as an introduction duct 8 of at least one sealing element 10, 12 inside the valve body 2, positioning the element 10, 12 in the sealing seat 4, 46;
iii) through the introduction duct 8, positioning at least one hollow ball 14 in the ball seat 6, in abutment with the sealing element 10, 12, whereby the ball 14 is movable in the seat 6 thereof with respect to the valve body 2 to allow/prevent the fluidic communication between the various ducts 8, 8′, 8″;
iv) connecting a ball-compressing element 16, delimiting a further sealing seat 4′ to receive another sealing element 10′, to the introduction duct 8 of the valve body 2 to press such element 10′ against the hollow ball 14.

According to a particularly advantageous embodiment, the step ii) comprises a step of positioning an elastic element 24 at least at one sealing seat 4, 4′, 46, in particular between the sealing element 10, 12 and the valve body 2 and/or between the sealing element 10′ and the ball-compressing element 16.

According to an advantageous aspect of such solution, the elastic element 24 is compressible by the hollow ball 14 during the step iii) of inserting it into, and possibly removing it from, the ball seat 6.

According to a further variant, the method may comprise the sub-steps of: a) upstream step iii) and by means of the introduction duct 8, inserting a control rod 28 in the valve body 2; b) arranging the rod in a rod seat 30 delimited by a valve body 2, adjacent to the ball seat 6, in a manner partially protruding from the valve body 2; c) during step iii), engaging the control rod 28 in an outer slit 32 of the hollow ball 14.

Innovatively, the valve and the method object of the present invention allow to effectively overcome the drawbacks complained in relation to the prior art.

More precisely, the present valve and the present method are designed to reduce the number of ball-compressing elements associated to the valve body, and to considerably limit encumbrance and use of materials required for manufacturing such valve.

Advantageously, the valve and the method object of the present invention allow to obtain a substantially full passage of fluid inside the valve, since the ducts are essentially free of bottlenecks, both upstream and downstream the ball.

Advantageously, with parity of fluid delivered, the valve and the method of the present invention allow to achieve smaller, lighter valves manufactured in a more economical manner.

Advantageously, the valve of the present invention allows to obtain sealing seats perfectly aligned to one another, with a consequent increase of reliability.

Advantageously, the valve of the present invention is extremely versatile with regard to the possibility of connecting to various kinds of installations.

Advantageously, the valve and the method of the present invention allow to obtain an extremely easier mounting, since the seals are not stressed (and therefore not at risk of deterioration) when inserting the ball into the valve body.

Advantageously, the valve of the present invention has an extremely reliable and reproducible operation, particularly thanks to the measures described above.

A skilled in the art, in order to meet specific needs, may introduce to the embodiments of the ball valve and of the aforesaid method, changes and variants or replacements of elements with other functionally equivalent.

In addition, such variants are contained within the scope of protection as defined by the following claims.

Furthermore, each variant described as belonging to a possible embodiment is feasible independently from the other described variants.

1.-10. (canceled)

11. A ball valve comprising:
a valve body delimiting at least one sealing seat, a ball seat and at least three fluidic ducts that converge in the ball seat;
at least one hollow ball, received in the ball seat and movable with respect to the valve body to allow or prevent a fluidic communication between said fluidic ducts;
two or more sealing elements, at least one of the two or more sealing elements is placed in the sealing seat in abutment with said ball;
wherein only one of said fluidic ducts acts as an introduction duct of one of the sealing elements and of the hollow ball inside the valve body, for positioning said element and said ball respectively in the sealing seat and in the ball seat;
a ball-compressing element delimiting a further sealing seat to receive the other sealing element and connected to the introduction duct of the valve body to press said element against the hollow ball;
wherein the valve body delimits three sealing seats, and wherein said ball valve comprises sealing elements in equal number with respect to a number of the sealing seats;
a reinforcement element coupled to one or more of the sealing elements, at least partially inserted into the sealing seat to limit deformation of said one or more sealing elements upon movement of the hollow ball in the ball seat;
the reinforcement element being at least partially received in the one or more sealing elements and, with respect to a development axis around which one or more of said fluidic ducts develop, the reinforcement element being arranged only radially internally with respect to the one or more sealing elements.

12. The valve according to claim 11, wherein the introduction duct circumscribes a transit section larger than the encumbrance of the hollow ball and larger than the encumbrance of the sealing elements associated to the valve body.

13. The valve according to claim 11, wherein the hollow ball defines a through cavity through the hollow ball having at least one annular inlet of a size at least equal to, or greater than, an inner edge of the sealing element received in the valve body.

14. The valve according to claim 11, comprising an elastic element in correspondence of at least one sealing seat, between the sealing element and the valve body and/or between the sealing element and the ball-compressing element, said elastic element being compressible by the hollow ball to insert the hollow ball into, and eventually remove the hollow ball from, the ball seat.

15. The valve according to claim 11, wherein the reinforcement element is annular or tubular.

16. The valve according to claim 11, wherein at least three fluidic ducts develop around development axes that lie substantially in a same plane, and comprising an fourth duct that develops around a further development axis incident or orthogonal to said plane.

17. The valve according to claim 11, wherein the valve body delimits three or four fluidic ducts.

18. The valve according to claim 11, in which the hollow ball identifies inside the hollow ball a substantially cylindrical through cavity, or having an “L” or “T” shape.

19. A method of fabrication of a ball valve according to claim 11, comprising the steps of:
i) providing a valve body that delimits three sealing seats, a ball seat and at least three fluidic ducts that converge in the ball seat;
ii.a) through only one of said fluidic ducts, which serves as an introduction duct of sealing elements in equal number with respect to a number of the seats inside the valve body, positioning said elements in the sealing seats;
ii.b) introducing a reinforcement element into the valve body, at the sealing seat, by the introduction duct; wherein the reinforcement element is at least partially received in the sealing element and, with respect to a development axis around which one or more of said fluidic ducts develop, the reinforcement element is arranged only radially internally with respect to the sealing element;
iii) through the introduction duct, positioning at least one hollow ball in the ball seat, in abutment with said sealing elements, said ball being movable with respect to the valve body to allow/prevent the fluidic communication between said ducts;
iv) connecting a ball-compressing element, delimiting a further sealing seat to receive another sealing element, to the introduction duct of the valve body to press said element against the hollow ball.

20. Method according to claim 11, wherein step ii) comprises a step of positioning an elastic element in correspondence of at least one sealing seat, between the sealing element and the valve body and/or between the sealing element and the ball-compressing element, said elastic element being compressible by the hollow ball during step iii) to insert the hollow ball into, and possibly remove the hollow ball from, the ball seat.
